(19) United States
(12) Patent Application Publication
(10) Pub. No.: US 2008/0065398 A1
(43) Pub. Date: Mar. 13, 2008

(54) Postal/deliverable matter delivery route developing apparatus and method of developing postal/deliverable matter delivery route

(75) Inventor: Hitoshi Morita, Kanagawa-ken (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/518,146

(22) Filed: Sep. 11, 2006

(51) Int. Cl. G06Q 50/00

(52) U.S. Cl. 705/1

(57) ABSTRACT

A postal/deliverable matter delivery route developing apparatus includes feeder which supplies the postal/deliverable matter, reading means for reading the sorting information of the postal/deliverable matter fed from this feeder, memory means for memorizing sorting information of the postal/deliverable matter fed from the feeder, destination information sorted based on the sorting information, and charging order, destination configuring means for configuring the destination of the postal/deliverable matter, segment boxes for accumulating therein the postal/deliverable matter sent in based on the sorting information read by the reading means, storage box for holding the accumulated postal/deliverable matters taking out from the segment boxes by being respectively divided in a prescribed order, calculating means for calculating the destination and the order of the postal/deliverable matter based on the sorting information, the destination, and the order which were memorized by the memory means when the postal/deliverable matters are moved from the box to the feeder and it succeeds in the secondary sorting operation, judging means for judging whether the postal/deliverable matters are charged according to the destination and the order calculated by the calculating means, and charging mistake warning means for issuing warning when it is judged that the postal/deliverable matters are out of order detected by the judging means.

### CROSS-REFERENCE TO RELATED APPLICATIONS

This application is relies for priority on Japanese Patent Application JP2005-264032 filed on Sep. 12, 2005, the entire contents of which is incorporated herein by reference.

### FIELD OF THE INVENTION

This invention relates to a postal/deliverable matter delivery route developing apparatus which prevents a operation mistake in rearranging the postal/deliverable matters in the predetermined order, and a method of developing postal/deliverable matter delivery route.

### BACKGROUND OF THE INVENTION

A postal/deliverable matter delivery route developing apparatus carries out sorting and accumulation of the postal/deliverable matters to the segment boxes configured beforehand based on the reading result of the delivery sorting information of the postal/deliverable matter. In this postal/deliverable matter delivery route developing apparatus, delivery route developing is carried out twice the postal/deliverable matter sorting operation in which postal/deliverable matters are charged and sorted, about the same postal/deliverable matter. In this case, the first postal/deliverable matter sorting operation is called primary sorting operation or a primary pass, and the second postal/deliverable matter sorting operation is called secondary sorting operation or a secondary pass.

In the primary sorting operation the postal/deliverable matters subjected to the delivery route developing are charged in random order. After the sorting operation has completed for the entire of the postal/deliverable matters, the postal/deliverable matters accumulated in the segment boxes are extracted in the order specified beforehand, and moved to a storage box.

In the secondary sorting operation, the postal/deliverable matters are taken out from the storage box and charged in the order stored in the storage box. Under the present circumstances, by charging all the postal/deliverable matters to a feeder in the order as it is, the postal/deliverable matters are accumulated in the segment boxes in a state that delivery route developing is correctly carried out.

However, in the conventional delivery route developing carried out by doing in this way, a delivery route may be wrongly developed by the man-caused working mistake as follows.

(1) After a primary sorting operation end, when moving the postal/deliverable matters accumulated by the segment boxes to a box, an operator mistakes the charging order.

(2) At the time of secondary sorting operation, an operator mistakes the charging order of postal/deliverable matters from a box, and charges to a feeder.

When such a man-caused mistake is not noticed during the operation but revealed at a first during delivering of the postal/deliverable matters developed the delivering route.

When sorting operation (sorting shelf surface setup) in which the order configured beforehand is not followed as a working mistake prevention method at the time of developing the delivery route, the method of issuing warning is known by Japanese Patent Application JP2002-166230A.

However, in the method of patent-document 1 the warning is issued when an operator mistook the charging order and set up sorting shelf surface before conveying postal/deliverable matter. And although the sorting shelf surface setup was set up correctly but the charging order of the postal/deliverable matters was mistook, the delivery route developing results in failure.

### SUMMARY OF THE INVENTION

The invention is devised to eliminate the above described disadvantage. Therefore the present invention has an object to provide a postal/deliverable matter delivery route developing apparatus capable of issuing warning and calling an operator's attention when judged a charging mistake at a secondary sorting operation and a method of developing postal/deliverable matter delivery route.

To achieve the above objects, the postal/deliverable matter delivery route developing apparatus of a first aspect according to the present invention is provided with feeder which supplies the postal/deliverable matter, reading means for reading the sorting information of the postal/deliverable matters fed from this feeder, memory means for memorizing sorting information of the postal/deliverable matters fed from the feeder, destination information sorted based on the sorting information, and charging order, destination configuring means for configuring the destination of the postal/deliverable matter, segment boxes for accumulating therein the postal/deliverable matters sent in based on the sorting information read by the reading means, storage box for holding the accumulated postal/deliverable matters taking out from the segment boxes by being respectively divided in a prescribed order, calculating means for calculating the destination and the order of the postal/deliverable matters based on the sorting information, the destination, and the order which were memorized by the memory means when the postal/deliverable matters are moved from the box to the feeder and it succeeds in the secondary sorting operation, judging means for judging whether the postal/deliverable matters are charged according to the destination and the order calculated by the calculating means, and charging mistake warning means for issuing warning when it is judged that the postal/deliverable matters are out of order by this judging means.

Further a method of developing postal/deliverable matter delivery route according the second aspect of the present invention includes the steps of primary charging the postal/deliverable matters into a feeder, configuring the destination of the charged postal/deliverable matter, feeding the postal/deliverable matters from the feeder, reading the sorting information of the postal/deliverable matters fed from the feeder, memorizing the sorting information of the postal/deliverable matter, the destination and the order read at the reading step, calculating an order of accumulation in segment boxes based on the sorting information, the destination, and the order which were memorized at the memorizing step, accumulating the postal/deliverable matters in the segment boxes according to the order calculated at the calculating step, taking out the postal/deliverable matters accumulated in the segment boxes in a predetermined order, making the postal/deliverable matters taken out from the segment boxes store in a storage box in a predetermined order by sorting respectively, secondary charging the postal/deliverable matters by taking out from the storage box into the feeder in a predetermined order, feeding the charged postal/deliverable matters from the feeder, judging whether the postal/deliverable matters have been charged at the secondary charging step according to the destination and the order calculated at the calculating step, and issuing charging mistake warning in case of that the charging order differs to the order judged in the judging step.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a drawing showing the conveying path of the postal/deliverable matter delivery route developing apparatus by the embodiment of the present invention.

FIG. 2 is a flowchart explaining a delivery route developing step.

FIG. 3 is a drawing showing a rearrangement, ¦, é situation at the delivery route developing step which postal/deliverable matter shows in FIG. 2.

FIG. 4 is a flowchart explaining a charging mistake warning process.

### DESCRIPTION OF THE PREFERRED EMBODIMENTS

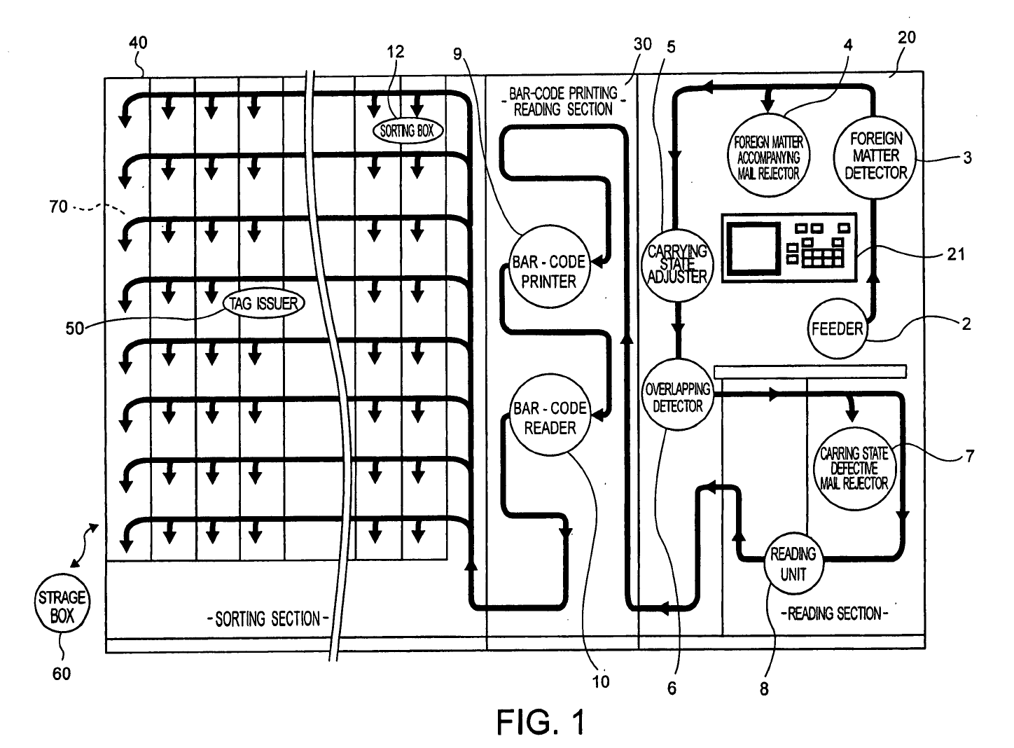

The present invention will be described in detail with reference to the FIGS. 1 through 4.

FIG. 1 is a drawing showing a conveying path of the postal/deliverable matter delivery route developing apparatus for sorting postal/deliverable matters, such as direct mail according to the embodiment of the present invention. This postal/deliverable matter delivery route developing apparatus comprises a conveying path (not shown), sorting information reading section (reading means) 20, bar-code printing reading section 30, and sorting section 40.

The above-mentioned conveying path (transportation means) conveys the postal/deliverable matters fed from feeder 2 to sorting information reading section 20, bar-code printing and bar-code printing reading section 30, and sorting section 40.

The above-mentioned sorting information reading section 20 reads the sorting information of the postal/deliverable matters conveyed from feeder 2. This sorting information reading section 20 has foreign matter detector 3, foreign matter accompanying mail rejecter 4, carrying state adjuster 5, overlapping detector 6, carrying state defective mail rejecter 7, reading unit 8, and operation display unit 21.

Foreign matter detector 3 detects the foreign matter which accompanies postal/deliverable matter. The postal/deliverable matter as which a foreign matter was not detected is conveyed to carrying state adjuster 5, and the postal/deliverable matter as which the foreign matter was detected is conveyed to foreign matter accompanying mail rejecter 4.

Carrying state adjuster 5 caries out ready grade of the gap generated when fed from the above-mentioned feeder 2, or the carrying state of postal/deliverable matter corrected skew. The postal/deliverable matter corrected conveying state is conveyed to overlapping detector 6.

Overlapping detector 6 detects postal/deliverable matter with faulty conveying postures, such as overlapping of postal/deliverable matters. The detected conveying posture poor postal/deliverable matters are eliminated by carrying state defective mail rejecter 7. The postal/deliverable matter with conveying posture in allowable limit is conveyed to reading unit 8.

Reading unit 8 reds the delivery sorting information (information showing destination) printed by postal/deliverable matter. The postal/deliverable matters are accumulated in segment boxes 12 based on this recognition result.

Above-mentioned bar-code printing reading section 30 read the information which shows the destination printed by the first page of postal/deliverable matter in the above-mentioned sorting information reading section 20. It has bar-code printer 9 which prints an ID code or machine code to the first page of postal/deliverable matter based on read result, and bar-code reader 10 for reading the bar-code printed by the bar-code printer 9.

The above-mentioned sorting section 40 has segment boxes 12 and tag issuer 50, based on the read result by reading unit 8 and bar-code reader 10 which recognize the information which shows a destination, classifies postal/deliverable matter and is accumulated.

The operation display unit 21 is equipped with the operation display as a destination configuring means by which an operator sets up a destination. The operation display is provided with configuring means for selectively configuring the destination when the postal/deliverable matters are primary charged, and a configuring means for configuring the delivery route when the postal/deliverable matters are secondary charged.

Thus, the destination set up comprises actually a sorting shelf surface to which the grouping of the segment boxes was carried out, and an operator will set up by choosing this sorting shelf surface according to the content which classifies postal/deliverable matter.

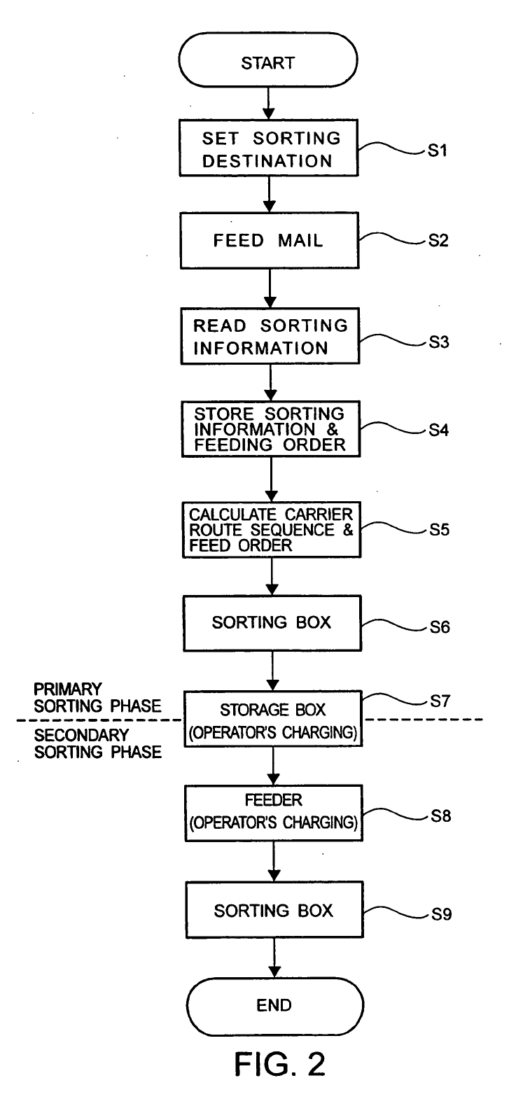

FIG. 2 is a flowchart explaining the delivery route developing operation according to the embodiment. A destination is first set up from an operation display (destination configuring means) by the operator (S1).

Next, primary sorting operation is carried out. In this primary sorting operation, the postal/deliverable matter which perform delivery route developing is charged to feeder 2 at order immobility (S2).

Next, as for the fed postal/deliverable matter, sorting information is read by the reading section (S3).

Next, the sorting information of the postal/deliverable matter accumulated on the destination of the postal/deliverable matter read at this read step and the destination and the order of the postal/deliverable matter are memorized (S4).

Next, the order of developing delivery route is calculated based on the destination, sorting information, and the order which were memorized by this memory step (S5).

Next, based on the sorting information read at the read step, the postal/deliverable matters are accumulated on the segment boxes which is the destination set up by the setting step (S6).

Next, the postal/deliverable matter accumulated at the accumulation step is taken out in the predetermined order, it classifies respectively, and is kept by the operator at a storage box (S7).

Next, secondary sorting operation is carried out. In this secondary sorting operation, it is sorted by primary sorting operation, and the postal/deliverable matter currently kept by the box is taken out in the order which was able to be configured beforehand, and it is charged to feeder 2 (S8).

It is judged whether the order of the postal/deliverable matter charged to feeder 2 is in agreement with the order calculated at the calculation step at the time of primary sorting operation (S9).

If the decision result of this determination step (S9) is in agreement with the order calculated at the time of primary sorting operation and it puts in and is not in agreement to a predetermined segment boxes, it issues warning of charging mistake (S110).

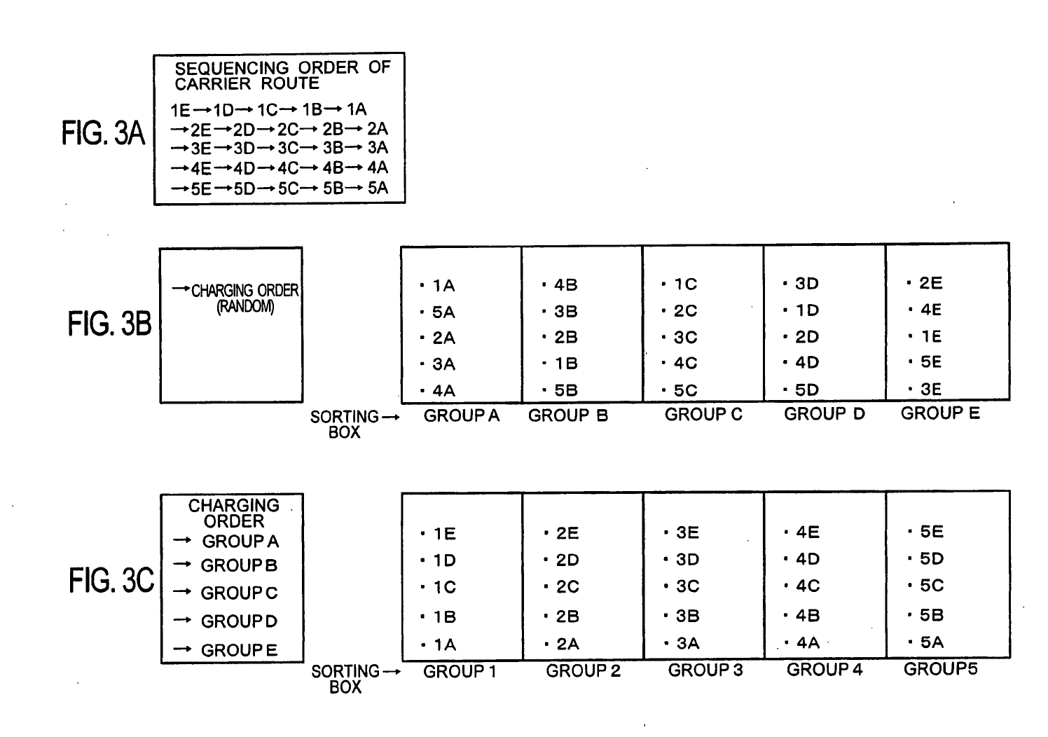

FIG. 3 is a drawing explaining the situation of rearrangement of postal/deliverable matter carried out by the delivery route developing operation shown in FIG. 2.

FIG. 3a shows an example of the order of delivery route developing. Here, it is assumed that destination of the postal/deliverable matter has been registered so as to develop the delivery route in following order.

P1 E-P1 D-P1 C-P1 B-P 1A . . . group 1

P2 E-P2 D-P2 C-P2B-P2A . . . group 2

P3 E-P3 D-P3C-P3 B-P 3A . . . group 3

P4 E-P4 D-P4 C-P4 B-P 4A . . . group 4

P5 E-P5 D-P5 C-P5 B-P 5A . . . group 5

Here, the postal/deliverable matter of group A (P*A)—group E (P*E) are charged based on delivery sorting information. That is, group A postal/deliverable matters P1 A-P 4A, group B postal/deliverable matters P1 B-P 4B, group C postal/deliverable matters P1 C-P 4C, group D postal/deliverable matters P1 D-P 4D, and group E postal/deliverable matters P1 E-P 4E are intermingled. Such postal/deliverable matters are charged into a postal/deliverable matter delivery route developing apparatus at the time of primary sorting operation.

FIG. 3b is a drawing showing the state where postal/deliverable matter was sorted to the segment boxes of group A-group E, and accumulated therein after primary sorting operation.

P4A, P3A, P2A, P5A, P1A . . . group A

P5B, P1B, P2B, P3B, P4B . . . group B

P5C, P4C, P3C, P2C, P1C . . . group C

P5D, P4D, P2D, P1D, P3D . . . group D

P3E, P5E, P1E, P4E, P2E . . . group E

FIG. 3c is a drawing showing the state where postal/deliverable matter was sorted to the segment boxes of group 1-group 5, and it was accumulated after secondary sorting operation. At the time of this secondary sorting operation, postal/deliverable matters are charged to feeder 2 in a following order of (1)-(5) according to the order in the storage box 60 that the postal/deliverable matters moved from segment boxes, after primary sorting operation.

(1) Charge group A postal/deliverable matter P4A, P3A, P2A, P5A, and P1A to feeder. The charged postal/deliverable matters are sorted as follows. Mail P1A is sorted to segment box group 1, postal/deliverable matter P2A is sorted to segment box group 2, postal/deliverable matter P3A is sorted to segment box group 3, postal/deliverable matter P4A is sorted to segment box group 4, and postal/deliverable matter P5A is sorted to segment box group 5.

(2) Charge group B postal/deliverable matter P5B, P1B, P2B, P3B, and P4B to feeder. The charged postal/deliverable matters are sorted as follows. Postal/deliverable matter P1 is sorted to segment box group 1, and postal/deliverable matter P2B is sorted to segment box group 2; postal/deliverable matter P3B is sorted into segment box group 3; postal/deliverable matter P4B is sorted into segment box group 4; and postal/deliverable matter P5B is sorted to segment box group 5, respectively.

(3) Charge group C postal/deliverable matter P5C, P4C, P3C, P2C, and P1C to feeder. The charged postal/deliverable matters are sorted as follows. Postal/deliverable matter P1C is sorted to segment box group 1, postal/deliverable matter P2C is sorted to segment box group 2, postal/deliverable matter P3C is sorted to segment box group 3, postal/deliverable matter P4C is sorted to segment box group 4, and postal/deliverable matter P5C is sorted to segment box group 5.

(4) Supply group D postal/deliverable matter P5D, P4D, P2D, P1D, and P3D to feeder. The fed postal/deliverable matters are sorted as follows. Postal/deliverable matter P1D is sorted to segment box group 1, postal/deliverable matter P2D is sorted to segment box group 2, postal/deliverable matter P3D is sorted to segment box group 3, postal/deliverable matter P4D is sorted to segment box group 4, and postal/deliverable matter P5D is sorted to segment box group 5.

(5) Charge group E postal/deliverable matter P3E, P5E, PIE, P4E, and P2E to feeder. The fed postal/deliverable matters are sorted as follows. (6) Feed group E postal/deliverable matter P3E, P5E, PIE, P4E, and P2E to feeder. The charged postal/deliverable matters are sorted as follows. Postal/deliverable matter P1E is sorted to segment box group 1; postal/deliverable matter P2E is sorted to segment box group 2; postal/deliverable matter P3E is sorted to segment box group 3; postal/deliverable matter P4E is sorted to segment box group 4; and postal/deliverable matter P5E is sorted to segment box group 5.

As for the above result, delivery route developing of the postal/deliverable matters are carried out to the order of the delivery route developing mentioned above, and it is sorted to it.

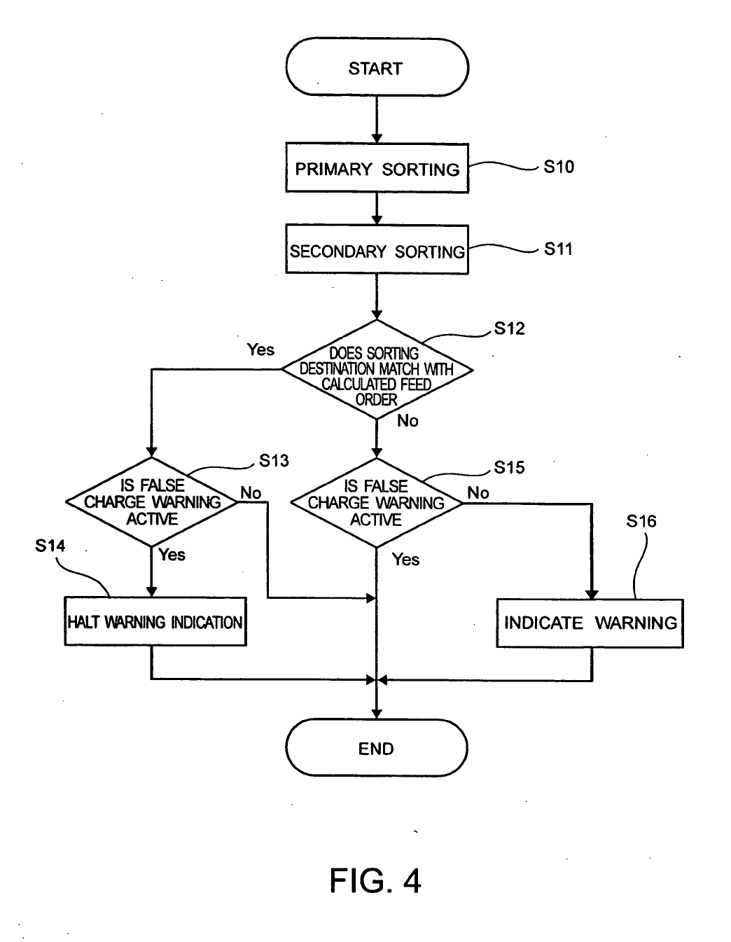

FIG. 4 is a flowchart showing charging mistake warning process. This flowchart explains the warning process carried out when a charging mistake occurs in the delivery route developing step explained in FIG. 2. Since a primary sorting phase and a secondary sorting phase are carried out as shown in FIG. 2 or 3 having explained, detailed description is omitted. It is verified whether the destination of the postal/deliverable matter fed during this secondary sorting phase is in agreement with the charging order calculated at the time of a primary sorting phase (S1-S 12).

If it is during the warning sign of a charging mistake when the charging order of the postal/deliverable matter fed in the secondary sorting phase is in agreement with the charging order calculated at the time of a primary sorting phase as a result of this verification (Yes in S12) (Yes in S13), a charging mistake warning sign will be eliminated (S14) and the charging mistake warning is continued. A warning sign is eliminated when the charging order of postal/deliverable matters are corrected after the charging mistake warning was carried out. On the other hand, if it is not during the warning sign of a charging mistake (No in S13), a charging mistake warning process will be carried out continuously.

In case of the charging order of the postal/deliverable matter fed in the secondary sorting phase is not in agreement with the charging order calculated at the time of a primary sorting phase (No in S12), the charging mistake warning is continued display when the charging mistake warning is in operation (Yes in S15). On the other hand, when the charging mistake warning is not in operation (No in S15) the charging mistake warning is carried out and continued warning operation (S16). As described above, the present invention can provide an extremely preferable postal/deliverable matter delivery route developing apparatus and method of developing postal/deliverable matter delivery route.

That is, according to the present invention, it is able to issue warning and call an operator's attention when judged a charging mistake at a secondary sorting operation. Therefore, it is able to prevent that the sorting operation is continued as the order of large amounts of postal/deliverable matters having been mistook.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

What is claimed:

1. A postal/deliverable matter delivery route developing apparatus, comprising:
feeder which supplies the postal/deliverable matter;
reading means for reading the sorting information of the postal/deliverable matter fed from this feeder;
memory means for memorizing sorting information of the postal/deliverable matter fed from the feeder, destination information sorted based on the sorting information, and charging order;
destination configuring means for configuring the destination of the postal/deliverable matter;
segment boxes for accumulating therein the postal/deliverable matter sent in based on the sorting information read by the reading means;
storage box for holding the accumulated postal/deliverable matters taking out from the segment boxes by being respectively divided in a prescribed order;
calculating means for calculating the destination and the order of the postal/deliverable matter based on the sorting information, the destination, and the order which were memorized by the memory means when the postal/deliverable matters are moved from the box to the feeder and it succeeds in the secondary sorting operation;
judging means for judging whether the postal/deliverable matters are charged according to the destination and the order calculated by the calculating means; and
charging mistake warning means for issuing warning when it is judged that the postal/deliverable matters are out of order detected by the judging means.

2. A postal/deliverable matter delivery route developing apparatus, as claimed in claim 1, wherein
the destination configuring means is provided with:
means for performing selectively configuring of the destination when succeeding in the sorting operation the whose postal/deliverable matters are the first time; and
operation display means provided with an information display means served for second charging of the postal/deliverable matter sorting operation to the feeder is presented, and an alter operation part.

3. A postal/deliverable matter delivery route developing apparatus, as claimed in claim 1,
wherein the warning means is so constituted that
in case of the destination of the postal/deliverable matter charged in the second time agreeing with the destination and the order calculated by the calculating means, the warning means pauses the warning operation when the charging mistake warning is in operation while the warning means continues the warning operation when the charging mistake warning is not in operation, and
in case of the destination of the postal/deliverable matter charged in the second time disagreeing with the destination and the order calculated by the calculating means, the warning means continues the warning operation when the charging mistake warning is in operation while the warning means pauses the warning operation when the charging mistake warning is not in operation.

4. A method of developing postal/deliverable matter delivery route by reading sorting information of postal/deliverable matter and sorting the postal/deliverable matter into the destination configured by destination configuring means, comprising the steps of:
primary charging the postal/deliverable matter into a feeder;
configuring the destination of the charged postal/deliverable matter;
feeding the postal/deliverable matter from the feeder;
reading the sorting information of the postal/deliverable matter fed from the feeder;
memorizing the sorting information of the postal/deliverable matter, the destination and the order read at the reading step;
calculating an order of accumulation in segment boxes based on the sorting information, the destination, and the order which were memorized at the memorizing step;
accumulating the postal/deliverable matter in the segment boxes according to the order calculated at the calculating step;
taking out the postal/deliverable matter accumulated in the segment boxes in a predetermined order;
making the postal/deliverable matter taken out from the segment boxes store in a storage box in a predetermined order by sorting respectively;
secondary charging the postal/deliverable matter by taking out from the storage box into the feeder in a predetermined order;
feeding the charged postal/deliverable matter from the feeder;
judging whether the postal/deliverable matter has been charged at the secondary charging step according to the destination and the order calculated at the calculating step; and
issuing charging mistake warning in case of that the charging order differs to the order judged in the judging step.

5. A method of developing postal/deliverable matter delivery route as claimed in claim 4, wherein the charging mistake warning issuing step has the steps of,
in case of the destination of the postal/deliverable matter as secondary charged agreeing with the destination and the order calculated in the calculating step, pausing warning operation when charging mistake warning is in operation while continuing the warning operation when the charging mistake warning is not in operation, and
in case of the destination of the postal/deliverable matter as secondary charged disagreeing with the destination and the order calculated by the calculating step, continuing the warning operation when the charging mistake warning is in operation while changing to the warning operation when the charging mistake warning is not in operation.
